(19) United States
(12) Patent Application Publication
(10) Pub. No.: US 2024/0342772 A1
(43) Pub. Date: Oct. 17, 2024

(54) APPARATUS FOR PRE-CLEANING OF SURGICAL INSTRUMENTS

(71) Applicant: TINY AIR LIMITED, Castle Douglas (GB)

(72) Inventors: Gordon HOWAT, Castle Douglas (GB); David RALSTON, Castle Douglas (GB); Christopher HELSON, Castle Douglas (GB)

(21) Appl. No.: 18/579,739

(22) PCT Filed: Jul. 19, 2022
(86) PCT No.: PCT/GB2022/051861

§ 371 Date: Jan. 16, 2024

(30) Foreign Application Priority Data
Jul. 19, 2021 (GB) 2110361.9

(51) Int. Cl. B08B 9/34; B08B 3/02; B08B 13/00

(52) U.S. Cl. CPC B08B 9/34; B08B 3/024; B08B 13/00

(57) ABSTRACT

The present invention provides apparatus (100, 200, 300) for cleaning an item. The apparatus comprises: a perforated member (103, 203, 303) for supporting an item to be cleaned; at least one upper nozzle (101a, 101b, 201a, 201b, 301) provided above the perforated member, directed in a downward direction, and for producing at least one first jet of fluid (104a, 104b, 204a, 204b, 304) to impinge upon the item when supported by the perforated member; and at least one lower nozzle (102, 202a, 202b, 302) provided beneath the perforated member, directed in an upward direction, and for producing at least one second jet of fluid (106, 206a, 206b, 306) to impinge upon the item when supported by the perforated member. The apparatus is configured such that when the at least one first jet and the at least one second jet are produced, the vertical component of a first jet force acting on the item to be cleaned from the at least one first jet is greater than the vertical component of a second jet force acting on the item to be cleaned from the at least one second jet.

### FIELD OF THE INVENTION

The present disclosure relates to an apparatus for and a method of cleaning an item, which item may typically be a surgical instrument.

### BACKGROUND TO THE INVENTION

During use, surgical instruments are often dirtied by strongly adhering materials, such as blood and bone. Such instruments subsequently require cleaning.

Currently, surgical instruments are often pre-cleaned in a sink with detergent, using a scrubbing brush. Once pre-cleaned of heavy contaminants, the instruments may be laid into a holder, typically a basket, and then loaded into a washer disinfector which uses a water jet of pressure typically around 1 Bar.

It is standard practice to have the instruments lying loosely in the basket. This allows for easy placement and removal of the instruments from the basket. Furthermore, physical clamping traps contamination and blocks cleaning. On the other hand, if loosely lying instruments are sprayed with sufficient force to clean from them tenacious contaminates such as cement, bone trapped in instrument teeth and blood, they could be damaged by being propelled out of the basket under reaction to the applied jet force.

It is in this context that the present invention has been devised.

### SUMMARY OF THE INVENTION

In accordance with an aspect of the present invention, there is provided an apparatus for cleaning an item. The apparatus comprises: a perforated member defining a surface for supporting an item to be cleaned; at least one upper nozzle provided above the perforated member, directed in a downward direction, and for producing at least one first jet of fluid to impinge upon the item when supported by the perforated member; and at least one lower nozzle provided beneath the perforated member, directed in an upward direction, and for producing at least one second jet of fluid to impinge upon the item when supported by the perforated member. The apparatus is configured such that when the at least one first jet and the at least one second jet are produced, the vertical component of a first jet force acting on the item to be cleaned from the at least one first jet is greater than the vertical component of a second jet force acting on the item to be cleaned from the at least one second jet.

Thus, the item to be cleaned can be retained at the surface of the perforated member as a result of the greater vertical component of the first jet force, acting on the item and holding the item against the surface. Nevertheless, the item can still be cleaned vigorously from both the upper side and the lower side by virtue of having both at least one first jet and at least one second jet to impinge upon the item. The result is that items can be effectively cleaned, using jets having a strength which might otherwise be sufficient to move the item across or even off the perforated member without requiring the item to be physically clamped to the perforated member. It will be understood that physical clamping or restraining of the item requires additional time and components, which can increase the time and training required for operation of such devices. Thus, examples which do not require clamping (or which require only a small amount of clamping) are particularly easy to use and the items can be loaded and unloaded quickly. Furthermore, the impingement between the downwardly projecting jet or jets and the upwardly projecting jet or jets (when there is no object provided between the two sets of jets) would occur below the level of the perforated member.

It will be understood that the perforated member is substantially any member having perforations defined therethrough, and through which fluid (e.g. liquid) from the lower jet can pass. The perforated member may be a basket. The perforated member May be a belt, such as a conveyor belt. The perforated member may be a tray. It may be that the perforated member is a substantially planar member defining a substantially planar surface. The perforated member may comprise one or more side walls. Thus, it can be further ensured that the item to be cleaned is retained at the perforated member. The perforated member may be a rigid member.

It may be that more than 30% of the surface of the perforated member is occupied by the perforations. It may be that more than 50% of the surface of the perforated member is occupied by the perforations. It may be that less than 99% of the surface area of the perforated member is occupied by the perforations. The perforations May each have an average cross-sectional area of at least 0.5 millimetres squared. The perforations may each have an average cross-sectional area of at least 1 millimetre squared. The perforations may each have an average cross-sectional area of less than 400 centimetres squared. The perforations may each have an average cross-sectional area of less than 100 centimetres squared.

It will be understood that the cleaning may be a precleaning. A precleaning May remove quantities of detritus or anatomical waste adhered to a surgical instrument prior to a further cleaning procedure. In other examples, it may be that the item is to be substantially completely cleaned with the apparatus.

The item for cleaning may be an instrument, for example a surgical instrument, such as scissors, clamps, retractors, forceps, or a bone rasp. The person skilled in the art will understand that the apparatus is dimensioned in correspondence with the size of the items which are intended for cleaning. In other words, the apparatus may be suitable for cleaning items greater than 2 centimetres in length. The apparatus May be suitable for cleaning items greater than 5 centimetres in length. The apparatus may be suitable for cleaning items greater than 10 centimetres in length. The apparatus may be unsuitable for cleaning items greater than 2 metres in length. The apparatus may be unsuitable for cleaning items greater than 1 metre in length. The apparatus may be configured to operate with the surgical instruments lying loosely on the perforated member. In other words, the apparatus may not include any physical clamps to retain the item to be cleaned in position at the perforated member.

Where the item to be cleaned is hinged, it may be that the item should be supported at the perforated member in an open configuration.

In some examples, the apparatus may comprise one or more clamps to at least partially hold the item to be cleaned in position at the perforated member.

After use, a surgical instrument is often covered in strongly adhering material such as blood and bone. The apparatus may be used to pre-clean a dirty surgical instrument of such heavy contamination prior to a deep cleaning treatment. In other examples, the apparatus may be used to substantially fully clean the dirty surgical instrument, without any need for a further cleaning treatment.

When the apparatus is in operation, fluctuations which may be present in the jets serve to buffet the item being cleaned. The item may also be buffeted by unbalanced components of the forces it is subjected to by the jets. In this way the item being cleaned may be agitated relative to the perforated member. As a result fresh areas of the item are exposed to the jets, thereby facilitating the cleaning action. If the item being cleaned is a hinged item, such as a pair of surgical scissors, the jiggling of the item by fluctuations in the forces acting on the item may cause movement of the hinge, opening and closing the hinge. In this way, additional surface areas of the item may be exposed to the cleaning jets, which areas might otherwise remain shadowed from the jets.

It will be understood that the at least one upper nozzle can be provided above the perforated member by being provided at any position higher than the perforated member. The at least one upper nozzle need not be provided directly vertically above the perforated member.

Similarly, it will be understood that the at least one lower nozzle can be provided beneath the perforated member by being provided at any position lower than the perforated member. The at least one lower nozzle need not be provided directly vertically below the perforated member.

In a preferred arrangement, the at least one upper nozzle an the at least one lower nozzle are positioned in opposition to one another. In this way, if a region of the item is impacted by a jet from the at least one lower nozzle, it would also be expected that the same region of the item will also be impacted, from the other side, by a jet from the at least one upper nozzle. As a result, it would be expected that forces caused to act on the item to be cleaned by virtue of a jet from the at least one lower nozzle, which might otherwise cause bulk movement of the item across or even off the perforated member, can be reduced or even completely eliminated by the opposing forced cause to act on the item to be cleaned by virtue of a jet from the at least one upper nozzle.

The item to be cleaned or being cleaned may be supported on the perforated member. The perforated member may typically be formed from a mesh or other openwork construction. Importantly, the perforated member has an open structure which gives both the downwardly projecting jet or jets and the upwardly projecting jet or jets direct access to the item, enabling the jets to have a particularly effective cleaning action on the item.

It will be understood that every jet produced by a nozzle of the apparatus, be that nozzle an upper nozzle or a lower nozzle, which impinges on an item, such as an item being cleaned, imparts a jet force on the item. Each jet force necessarily has a vertical component, that is to say a component acting in a vertical direction, and a horizontal component, that is to say a component acting in a horizontal direction.

When the apparatus is in operation, the downwardly projecting jet or jets and the upwardly projecting jet or jets impinge on the item, thereby dislodging material which is desired to be removed from the item. When a jet impinges on an item, such as an item being cleaned, it means that the jet comes into contact with the item and that the natural passage of the jet is thereby altered.

The fluid may preferably be a liquid. The fluid may comprise water. The fluid may be water. The fluid may be a cleaning fluid, including a cleaning agent.

A jet of fluid which is produced by an upper nozzle and is directed in a downward direction may typically impinge on the side of an item being cleaned which is furthest away from the perforated member supporting that item. This might be called the upper side, or upper face, of the item. Similarly, a jet of fluid which is produced by a lower nozzle and is directed in an upward direction may typically impinge on the side of an item being cleaned which is closest to or in contact with the perforated member supporting that item. This might be called the lower side, or lower face, of the item.

The jets of fluid which are produced are of high pressure. The use of high pressure jets results in the item, when it is impacted by a jet, being subjected to a force which is sufficient to clean surface debris from the item. By high pressure, it will be understood that the pressure of fluid is greater than atmospheric, for example at least twice atmospheric pressure. The pressure of fluid supplied to the nozzles may be greater than 101325 pascals (101.325×10³ pascals). The pressure may be greater than 200×10³ pascals. The pressure may be greater than 0.5×10⁶ pascals. The pressure may be greater than 1×10⁶ pascals. The pressure may be greater than 5×10⁶ pascals. The pressure may be less than 500×10⁶ pascals. The pressure may be less than 300×10⁶ pascals. The pressure may be less than 100×10⁶ pascals. The pressure may be approximately 15×10⁶ pascals.

A flow rate of fluid from each of the nozzles may be greater than 2 litres per minute. The flow rate may be greater than 4 litres per minute. The flow rate may be less than 50 litres per minute. The flow rate may be less than 20 litres per minute.

A velocity of the fluid at an outlet of each of the nozzles may be greater than 10 metres per second. The velocity may be greater than 50 metres. The velocity may be greater than 100 metres per second. The velocity may be less than 300 metres per second. The velocity may be less than 200 metres per second. The velocity may be approximately 140 metres per second.

Each nozzle may have an outlet diameter of less than 5 millimetres. Each nozzle May have an outlet diameter of less than 2 millimetres. Each nozzle may have an outlet diameter of greater than 0.25 millimetres. Each nozzle may have an outlet diameter of greater than 0.5 millimetres. Each nozzle may have an outlet cross-sectional area of less than 20 millimetres squared. Each nozzle may have an outlet cross-sectional area of less than 5 millimetres squared. Each nozzle may have an outlet cross-sectional area of greater than 0.1 millimetres squared. Each nozzle may have an outlet cross-sectional area of greater than 0.5 millimetres squared.

It may be that the at least one upper nozzle and the at least one lower nozzle are situated in a vertical plane, meaning the same vertical plane. It may be that the cleaning plane is vertical.

The apparatus is configured such that in use an item being cleaned is impinged upon by at least one upwardly projecting jet and at least one downwardly projecting jet. The invention may therefore clean both upper surfaces and lower surfaces of an instrument at the same time.

The apparatus may include a cleaning vessel. The cleaning operation of the apparatus would occur within the cleaning vessel and the vessel would typically contain the perforated member and the nozzles. A jet of fluid produced by a nozzle would remain within the cleaning vessel, even after the jet of fluid had encountered an object, such as an item being cleaned or another jet of fluid. The cleaning vessel may have walls for retaining the jets of fluid therein. It may be that the walls also prevent escape of biological contaminants from the cleaning apparatus into an external atmosphere after they have been dislodged from the item to be cleaned.

The at least one upper nozzle of the apparatus would typically be located in an upper region of the cleaning vessel. The at least one lower nozzle of the apparatus would typically be located in a lower region of the cleaning vessel, that is towards the surface on which the apparatus is provided, such as a ground surface.

A nozzle which produces a jet of fluid is a nozzle which is configured to produce a jet of fluid.

The shape and one or more other characteristics of any jet which is produced by the apparatus when in use may be determined by the nozzle used to produce the jet.

It may be that a nozzle is a nozzle which produces a diverging jet of fluid. That is to say, one upper nozzle may produce a diverging jet. Each of more than one upper nozzle may produce a diverging jet, or each of all the upper nozzles may produce a diverging jet. Similarly, one lower nozzle may produce a diverging jet, or each of more than one lower nozzle may produce a diverging jet, or each of all the lower nozzles may produce a diverging jet.

Each nozzle may be configured to produce a diverging jet of fluid. It will be understood that the cross-sectional area of a diverging jet of fluid increases as the jet becomes more distant from the nozzle. In this way fluid may be spread out to impact an increased area of an item being cleaned.

In some examples, it may be that at least one, or each jet of fluid is essentially constrained within a (e.g. respective) two-dimensional plane. By being essentially constrained in such a two-dimensional plane, the jet will have a fan shape but with a small thickness. The cross-sectional footprint of the jet may approximate to a rectangle, or even substantially to a line. As the jet becomes more distant from the associated nozzle, the rectangular cross-sectional area of the jet (or the length of the line) increases principally through an increase in length of each of two of its opposing sides, the length of the remaining two opposing sides (corresponding to the small thickness) staying largely constant. In this way a fan shaped jet is produced. The two-dimensional plane may be defined substantially parallel to a lateral direction of the perforated member, and perpendicular to the surface of the perforated member. Furthermore, a longitudinal direction of the apparatus is typically normal to the two-dimensional plane. In this way, as the perforated member moves relative to the nozzles in the longitudinal direction, the jets produce only a small, or even zero, resultant longitudinal force on the items to be cleaned on the perforated member, meaning that the items to be cleaned remain in their original locations on the perforated member during operation of the apparatus. Otherwise, the items to be cleaned could move longitudinally over the perforated member as the perforated member is moved relative to the nozzles, as a result of any resultant force from the jets having a substantial component in the longitudinal direction of the perforated member. Nevertheless, it will be understood that other orientations are possible.

It will be understood that a longitudinal direction of the apparatus is a direction corresponding to a length of the perforated member, and/or in which the perforated member may be movable relative to the nozzles. Typically, the longitudinal direction is parallel to the surface of the perforated member. Accordingly, a lateral direction of the apparatus is perpendicular to the longitudinal direction, otherwise to be considered as a direction corresponding to a width of the perforated member and/or the apparatus. The lateral direction is typically parallel to the surface of the perforated member.

In divergent jets it will be understood that the central area of the jet, away from a jet boundary, may either contain some of the fluid, or may be substantially devoid of fluid with the jet defining an annular spray pattern.

A divergent jet may typically subtend an angle of 40° between the angular extents of the jet. This angle may also be 10°, 15°, 20°, 25°, 30°, 35°, or 45°, or indeed any intermediate angle, any angle less than 10°, or any angle greater than 45°. For a fan shaped jet, the angle subtended may typically be 40°. The angle subtended by a fan shaped jet may also be 10°, 15°, 20°, 25°, 30°, 35°, or 45°, or indeed any intermediate angle, any angle less than 10°, or any angle greater than 45°. The divergent jet may subtend an angle less than 70°. The divergent jet may subtend an angle greater than 10°.

Where there are a plurality of nozzles providing a plurality of fan-shaped jets, it may be that a plane in which any of the fan-shaped jets is produced is parallel to a respective plane of each of the other fan-shaped jets. Typically, a plurality of the fan-shaped jets are produced in the same plane.

It is apparent to the person skilled in the art that the form of any jet which is produced by the apparatus when in use may be determined by the nozzle means which is used to produce the jet. A nozzle which produces a fan-shaped jet of fluid as spray pattern is known. Such a nozzle may be known as a flat fan nozzle. Where a flat fan nozzle is used, the jet may have a thickness of less than 10 mm, such as approximately 6 mm, or even less. The divergence of the fan-shaped jet in a direction normal to the plane of the fan shape may be less than five degrees, such as less than three degrees. Thus, the fan-shaped jet need not be completely non-divergent in directions normal to the plane of the fan.

In other examples, one or more of the nozzles may each be configured to produce a non-diverging jet of fluid. Thus, the cross-sectional size of the jet is substantially constant as it proceeds from the nozzle. Indeed, it may even be that the nozzles are configured to produce a converging jet of fluid, such that the cross-sectional size of the jet reduces as it proceeds from the nozzle, towards a focus point.

A nozzle may have associated with it a central axis, whereby the central axis may be defined as the central axis of the jet of fluid produced by the nozzle. The central axis may be considered to be the resultant direction in which the jet of fluid would be considered to be directed if the velocity vectors of all of the portions of fluid making up the jet of fluid were combined.

The at least one upper nozzle of the apparatus may be a plurality of upper nozzles, and the central axis of a first of the plurality of upper nozzles may be directed at least partially towards the central axis of a second of the plurality of upper nozzles. In a preferred arrangement, there may be two upper nozzles, and the central axis of each of these two upper nozzles may be directed towards the central axis of the other upper nozzle. This may be in a symmetric manner, so that each central axis is directed towards the other central axis by the same angle. A first of the plurality of upper nozzles may be arranged to direct a first associated jet in a first combined resultant direction at least partially towards a second combined resultant direction of a second associated jet for which a second of the plurality of upper nozzles is arranged.

Where the apparatus comprises a nozzle arrangement with two upper nozzles, the central axis of each of the two upper nozzles may be directed symmetrically towards the central axis of the other upper nozzle in such a way that an outer jet wall, for example an outer jet wall of each jet, is substantially vertical. An outer jet wall may be the outermost edge of a jet. The outermost edge will be understood to be the edge of the jet closest to the edge of the apparatus. It may be that any of the upper nozzles being outermost upper nozzles, are arranged to project a jet defining an outer jet wall on an outermost side which extends slightly outwardly, for example with an angle outward from the vertical of between 0 degrees and 15 degrees, for example less than 10 degrees. Thus, items to be cleaned by the apparatus can still be cleaned, even when provided in the corners of the perforated member, where the perforated member is provided with side walls extending upwardly therefrom, and one or more inwardly extending protrusions, such as a bar, extending inwardly from the side walls, within the footprint of the perforated member.

It may be that a direction of the outer jet wall of a given upper jet has a horizontal component less than the horizontal component of the inner jet wall of the given upper jet. It may be that a direction of the outer jet wall of at least two upper jets each have a horizontal component less than the horizontal component of the inner jet wall of the at least two upper jets. Thus, the jets are configured to generally bias the item to be cleaned towards a central region of the perforated member. It may be that the direction of the outer jet wall of the at least two upper jets has a horizontal component of zero or more in the direction of the horizontal component of the direction of the respective inner jet wall for each jet.

It may be that each of the outermost upper nozzles is configured such that the horizontal component of the direction of the respective outer jet wall in the outer direction is less than the horizontal component of the direction of the inner jet wall of the respective outermost upper nozzle in the inner direction. Thus, the nozzles are angled at least slightly inwardly, such that the central axis of the nozzle is inwardly directed. It may be that each of the outermost upper nozzles is configured such that the horizontal component of the direction of the respective outer jet wall in the outer direction is greater than zero and less than the horizontal component of the direction of the inner jet wall of the respective outermost upper nozzle in the inner direction. Thus, some of the jet from the outermost upper nozzles can penetrate into the corners of the perforated member, even when the perforated member is provided with side walls having a bar member extending inwardly therefrom.

It may be that the inner jet wall of the first of the plurality of upper nozzles May intersect with the inner jet wall of the second of the plurality of upper nozzles above the perforated member. Thus, there may be substantially unbroken coverage of the perforated member (and items provided thereon) from the jet of the first of the plurality of upper nozzles and the jet of the second of the plurality of upper nozzles. The intersection point between the central axes may be at least 10 millimetres off the perforated member. The intersection point may be at least 30 millimetres off the perforated member. The intersection point may be less than 100 millimetres off the perforated member. The intersection point may be less than 70 millimetres off the perforated member.

A point of intersection between the central axis of the first of the plurality of upper nozzles and the central axis of the second of the plurality of upper nozzles may be below the perforated member.

There may be more than two upper nozzles. There may be an even number of upper nozzles in this nozzle arrangement, whereby the central axis of each of the nozzles on one side of the nozzle arrangement is at least partially directed towards the central axis of each of the nozzles on the other side of the nozzle arrangement, in such a way that the total horizontal force available from the jets originating from one side of the nozzle arrangement is equal and opposite to that available from the jets originating from the other side of the nozzle arrangement. In this way, any item supported on the perforated member and being cleaned by jets from the nozzles is constantly being encouraged into a central position by the jets. If the item moves away from a central axis of the apparatus, the arrangement of the upper nozzles is such that there will be an increased horizontal force on the item from the jets pushing the item back towards the central plane of the apparatus, the central plane containing the longitudinal axis of the apparatus. In this way the item being cleaned is constantly being pushed towards the central plane of the apparatus. In this way unintentional sideways movement of the item to be cleaned is suppressed or stopped as there is always a sideways force tending to centre the item.

In an arrangement of the apparatus comprising more than two upper nozzles, each of the outermost upper nozzles may be configured such that a side of the downwardly directed first jet produced by that nozzle is substantially vertical. The outermost nozzles may be those nozzles at the outermost edge of a group of nozzles. The outermost nozzles may be the nozzles furthest from the longitudinal axis of the apparatus.

There may be more than two lower nozzles. There may be an even number of lower nozzles in this nozzle arrangement, whereby the central axis of each of the nozzles on one side of the nozzle arrangement is at least partially directed towards the central axis of each of the nozzles on the other side of the nozzle arrangement, in such a way that the total horizontal force available from the jets originating from one side of the nozzle arrangement is equal and opposite to that available from the jets originating from the other side of the nozzle arrangement. In this way, any item supported on the perforated member and being cleaned by jets from the nozzles is constantly being encouraged into a central position by the jets. If the item moves away from a central axis of the apparatus, the arrangement of the lower nozzles is such that there will be an increased horizontal force on the item from the jets pushing the item back towards the central plane of the apparatus, the central plane containing the longitudinal axis of the apparatus. In this way the item being cleaned is constantly being pushed towards the central plane of the apparatus. In this way unintentional sideways movement of the item to be cleaned is suppressed or stopped as there is always a sideways force tending to centre the item.

The at least one lower nozzle of the apparatus may be a plurality of lower nozzles, and the central axis of a first of the plurality of lower nozzles may be directed at least partially towards the central axis of a second of the plurality of lower nozzles. In a preferred arrangement, there may be two lower nozzles, and the central axis of each of these two lower nozzles may be directed towards the central axis of the other lower nozzle. This may be in a symmetric manner, so that each central axis is directed towards the other central axis by the same angle. A first of the plurality of lower nozzles may be arranged to direct a first associated jet in a first combined resultant direction at least partially towards a second combined resultant direction of a second associated jet for which a second of the plurality of lower nozzles is arranged. 34 Where the apparatus comprises a nozzle arrangement with two lower nozzles, the central axis of each of the two lower nozzles may be directed symmetrically towards the central axis of the other lower nozzle in such a way that an outer jet wall, for example an outer jet wall of each jet, is substantially vertical. An outer jet wall may be the outermost edge of a jet. The outermost edge will be understood to be the edge of the jet closest to the edge of the apparatus. It may be that any of the lower nozzles being outermost lower nozzles, are arranged to project a jet defining an outer jet wall on an outermost side which extends slightly outwardly, for example with an angle outward from the vertical of between 0 degrees and 15 degrees, for example less than 10 degrees. Thus, items to be cleaned by the apparatus can still be cleaned, even when provided in the corners of the perforated member, where the perforated member is provided with side walls extending upwardly therefrom, and one or more inwardly extending protrusions, such as a bar, extending inwardly from the side walls, within the footprint of the perforated member.

It may be that a direction of the outer jet wall of a given lower jet has a horizontal component less than the horizontal component of the inner jet wall of the given lower jet. It may be that a direction of the outer jet wall of at least two lower jets each have a horizontal component less than the horizontal component of the inner jet wall of the at least two lower jets. Thus, the jets are configured to generally bias the item to be cleaned towards a central region of the perforated member. It may be that the direction of the outer jet wall of the at least two lower jets has a horizontal component of zero or more in the direction of the horizontal component of the direction of the respective inner jet wall for each jet.

It may be that each of the outermost lower nozzles is configured such that the horizontal component of the direction of the respective outer jet wall in the outer direction is less than the horizontal component of the direction of the inner jet wall of the respective outermost lower nozzle in the inner direction. Thus, the nozzles are angled at least slightly inwardly, such that the central axis of the nozzle is inwardly directed. It may be that each of the outermost lower nozzles is configured such that the horizontal component of the direction of the respective outer jet wall in the outer direction is between zero and less than the horizontal component of the direction of the inner jet wall of the respective outermost lower nozzle in the inner direction.

It may be that the inner jet wall of the first of the plurality of lower nozzles may intersect with the inner jet wall of the second of the plurality of lower nozzles below the perforated member. Thus, there may be substantially unbroken coverage of the underside of the perforated member (and items provided on an upper surface thereof) from the jet of the first of the plurality of lower nozzles and the jet of the second of the plurality of lower nozzles.

In an arrangement of the apparatus comprising more than two lower nozzles, each of the outermost lower nozzles may be configured such that a side of the upwardly directed second jet produced by that nozzle is substantially vertical. The outermost nozzles may be those nozzles at the outermost edge of a group of nozzles. The outermost nozzles may be the nozzles furthest from the longitudinal axis of the apparatus.

The total number of upper nozzles may be equal to the total number of lower nozzles. Thus, the jets from the nozzles can effectively cancel each other out. The total number of nozzles may refer to the total number of nozzles, upper and/or lower, comprised either in an apparatus, or in a bank of nozzles of the apparatus. In other examples, there may be a different number of upper nozzles and lower nozzles, for example there may be more upper nozzles than lower nozzles.

The or each upper nozzle may be arranged relative to a respective lower nozzle such that the or each first jet intersects the respective second jet from the respective lower nozzle. The lower nozzles may be arranged to be symmetric with the upper nozzles about a horizontal plane. Thus, each upper nozzle has a corresponding lower nozzle.

The horizontal plane may be below the perforated member. In an arrangement of the apparatus in which there are at least two upper nozzles, it may be advantageous for the jets produced by at least some of the at least two nozzles to overlap at the perforated member. In this way, the whole of the item being cleaned is covered by the jets of fluid in a plane along which the nozzles are arranged. The overlap of jets at the level of the perforated member may typically be 25 mm or less.

The same considerations apply for a lower nozzle arrangement having at least two lower nozzles.

It may be that the shortest distance between the perforated member and the at least one upper nozzle is less than the shortest distance between the perforated member and the at least one lower nozzle. It may be that the vertical distance between the perforated member and the at least one upper nozzle is less than the vertical distance between the perforated member and the at least one lower nozzle. Such an arrangement assists in maintaining or producing the condition that, when the at least one first jet and the at least one second jet are produced, the vertical component of a first jet force acting on the item to be cleaned from the at least one first jet is greater than the vertical component of a second jet force acting on the item to be cleaned from the at least one second jet. For example, with an arrangement where the shortest distance between the perforated member and the at least one upper nozzle is less than the shortest distance between the perforated member and the at least one lower nozzle, the condition may be achieved while supplying the upper nozzle or nozzles with fluid at the same pressure as the fluid supplied to the lower nozzle or nozzles.

It may be that the difference between the shortest distance between the perforated member and the at least one upper nozzle and the shortest distance between the perforated member and the at least one lower nozzle need not be large in order to achieve the desired effect. For example, the effect can be seen if the vertical distance between the perforated member and the at least one upper nozzle is 60 mm, and the vertical distance between the perforated member and the at least one lower nozzle is 64 mm. In another example, the vertical distance or stand off from the surface of the perforated member to an upper nozzle may be approximately 60 mm, and the vertical distance or stand off from a lower surface of the perforated member to a lower nozzle may be approximately 80 mm.

The difference between the vertical distance from the at least one upper nozzle to the perforated member and from the at least one lower nozzle to the perforated member may be more than 5 millimetres. The difference between the vertical distance from the at least one upper nozzle to the perforated member and from the at least one lower nozzle to the perforated member may be less than 50 millimetres.

Thus, the jet or jets from the at least one upper nozzle may typically be expected to intersect with the jet or jets from the at least one lower nozzle below the perforated member. In this way, the intersection of the jets being below the basket ensures that the jet or jets from the at least one upper nozzle are never intersected by the jet or jets from the at least one lower nozzle until after they would already have had contact with the item to be cleaned, ensuring that the item to be cleaned remains clamped to the perforated member.

The vertical distance from the at least one upper nozzle to the perforated member may be greater than 40 millimetres. The vertical distance from the at least one upper nozzle to the perforated member may be greater than 60 millimetres. The vertical distance from the at least one upper nozzle to the perforated member may be less than 200 millimetres. The vertical distance from the at least one upper nozzle to the perforated member may be less than 100 millimetres. The vertical distance from the at least one lower nozzle to the perforated member may be greater than 40 millimetres. The vertical distance from the at least one lower nozzle to the perforated member may be greater than 60 millimetres. The vertical distance from the at least one lower nozzle to the perforated member may be less than 200 millimetres. The vertical distance from the at least one lower nozzle to the perforated member may be less than 100 millimetres.

The apparatus may comprise a nozzle control to selectively activate one or more of the nozzles. The nozzle control may selectively open and close any particular nozzle, so that the nozzle thereby either produces a jet of fluid or does not producing a jet of fluid. It may be that groups of nozzles are controlled together. Thus, nozzles that are not needed can be deactivated to reduce water consumption and energy consumption of the apparatus.

Nozzle control may be achieved by utilising a solenoid in connection with a nozzle. An electrical signal may be utilised to operate the solenoid, i.e. to open or shut a nozzle to produce or not to produce a jet of fluid. The apparatus may comprise one or more solenoids, each arranged to control a valve controlling fluid flow to one or more of the at least one upper nozzle and the at least one lower nozzle. The apparatus may further comprise a controller to provide a control signal to the solenoid to operate the solenoid.

The apparatus may comprise a nozzle controller to control selective activation of the at least one upper nozzle and the at least one lower nozzle.

By selectively opening and closing the nozzles water usage may be controlled. In this way, water wastage may be reduced.

At least one upper nozzle and at least one lower nozzle of the apparatus may be arranged in a first nozzle bank. The apparatus may comprise a plurality of nozzle banks. It will be understood that a nozzle bank is a grouping of nozzles, typically including both one or more upper nozzles and one or more lower nozzles. In some examples, a first nozzle bank may be associated with a first lateral position in the apparatus and one or more further nozzle banks may be associated with one or more further lateral positions in the apparatus. Each lateral position is different in the lateral direction, being perpendicular to the longitudinal direction and parallel to a plane of the perforated member. It may be that each nozzle bank comprises a plurality of nozzle groups, each longitudinally separated in the apparatus. In this way the apparatus may comprise a row of nozzle banks. Each nozzle bank may comprise a plurality of nozzles.

In other examples, it will be understood that each nozzle bank may instead be associated with a different respective longitudinal position in the apparatus. Each nozzle bank may comprise a plurality of nozzle groups, laterally separated in the apparatus.

At least one nozzle bank may comprise both upper nozzles and lower nozzles.

Each nozzle bank may comprise an equal number of upper nozzles and lower nozzles. A nozzle bank may comprise at least four nozzles in a first nozzle group. For example, a nozzle bank may comprise two upper nozzles and two lower nozzles in the first nozzle group. Each nozzle bank may comprise a plurality of nozzle groups, for example at least two nozzle groups. Each nozzle group may comprise an equal number of upper nozzles and lower nozzles, for example at least two upper nozzles and at least two lower nozzles.

Each nozzle bank may comprise more upper nozzles than lower nozzles, for example twice as many upper nozzles as lower nozzles. A nozzle bank may comprise three nozzles in a first nozzle group. For example, a nozzle bank may comprise two upper nozzles and one lower nozzle in the first nozzle group. Each nozzle bank may comprise a plurality of nozzle groups, for example at least two nozzle groups. Each nozzle group may comprise more upper nozzles than lower nozzles, for example twice as many upper nozzles as lower nozzles. Each nozzle group may comprise three nozzles. For example, each nozzle group may comprise two upper nozzles and one lower nozzle.

Each of the nozzle groups may overlap at least one other nozzle group in the nozzle bank in a direction perpendicular to the direction in which the nozzle banks are mutually spaced. In other examples, it may be that there is no overlap between nozzle groups in the nozzle bank in the direction perpendicular to the direction in which the nozzle banks are mutually spaced.

An apparatus of the present disclosure may comprise a row of nozzle banks spaced out along a longitudinal axis of the apparatus. In other words, the apparatus May comprise a first nozzle bank at a first longitudinal position of the apparatus and a second nozzle bank, spaced from the first nozzle bank, at a second longitudinal position of the apparatus.

Each of the nozzle banks may be controlled independently. Each of the nozzle groups in a given nozzle bank may be controlled together. In examples, at a first time, the nozzles of the first nozzle bank may be operational, whilst the nozzles of the second nozzle bank are controlled differently, such as to not operate. At a second time, the nozzles of the second nozzle bank may be operational, whilst the nozzles of the first nozzle bank are controlled differently, such as to not operate. In other examples, each of the nozzle groups in a given nozzle bank may be controller independently. In examples, at a first time, the nozzles of a first nozzle group of the first nozzle bank may be operational, whilst the nozzles of a second nozzle group in the first nozzle bank are controlled differently, such as to not operate. At a second time, the nozzles of the second nozzle group in the first nozzle bank may be operational, whilst the nozzles of the first nozzle group in the first nozzle bank are controlled differently, such as to not operate.

A source is required to supply fluid to the input of any nozzle which is for producing a jet of fluid within the apparatus. The fluid may be a liquid. The liquid may be or May comprise water. The fluid source correspondingly may be or may comprise a mains water supply. In such an arrangement, a fluidic connection may be established between a mains water supply and the input of any nozzle which is for producing a jet of fluid. Any other suitable source of fluid may also be used, for example a storage tank of fluid. A plurality of different sources, such as a water source and a source of detergent, may be fluidically connected to the input of a nozzle to produce for example jet of fluid comprising a dilute detergent.

The fluid may be water. In particular, water may be used if the cleaning is a precleaning procedure for removing debris from a heavily soiled or dirtied item. A precleaning procedure may be performed prior to a further deep cleaning. A further deep cleaning may utilise detergent.

A fluidic connection may be provided by a fluid conduit or a plurality of fluid conduits. A fluid conduit, or plurality of fluid conduits, may be connected between a fluid source, such as a water tank, and a nozzle, such as an upper nozzle or a lower nozzle. In this way fluid may be transported from the source to a nozzle from which a jet of fluid is produced.

The fluid source may be configured to supply fluid to a nozzle at a pressure which is adjustable. In this way the pressure of a jet produced by a nozzle may be controlled. The pressure of fluid exiting any one nozzle means may be regulated by the nozzle means itself, or it may be regulated by adjusting the pressure of fluid at the nozzle inlet.

The apparatus may comprise a pump for pumping fluid from the fluid source to the at least one upper nozzle and the at least one lower nozzle. Thus, the fluid can be further pressurised between the fluid source and the nozzles.

In some examples, the apparatus may comprise one or more variable flow valve to control the fluid flow provided to one or more nozzle banks of the apparatus. Thus, the fluid flow provided to a first nozzle bank may be controlled to be different to the fluid flow provided to a second nozzle bank. Where the apparatus comprises a central nozzle bank and at least one peripheral nozzle bank, it may be that the apparatus is configured to control the central nozzle bank to have a higher flow rate to each of the nozzles thereof than a fluid flow rate of each of the nozzles in the at least one peripheral nozzle bank. Thus, there may be more effective cleaning provided in a central lateral region of the perforated member.

The apparatus may further comprise a variable pump in fluid communication with one or more of the at least one upper nozzle and the at least one lower nozzle. The apparatus may further comprise a pump controller to control an output of the variable pump. In some examples, there may be a plurality of pumps, connected to different nozzle banks.

It may be that the output of the variable pump can be increased to provide enhanced cleaning capabilities as necessary.

The apparatus may be configured such that the perforated member is movable relative to the nozzles. Typically, the apparatus may be provided on a surface, and the nozzles remain stationary with respect to this surface. In such a typical configuration the relative movement between perforated member and nozzles is achieved through movement of the perforated member. It will be appreciated that in other examples, the perforated member remains stationary with respect to the environment in which the apparatus is provided and that the nozzles move. However this occurs, movement of the perforated member relative to the nozzles has the effect of moving an item which is supported by the perforated member relative to the jets of fluid produced by the nozzles. In this way the jets move relative to the surface of the item, enabling different regions of the item to be impacted by the jets and thereby facilitating a cleaning of the multiple regions of the surface of the item. The relative movement of the perforated member may be in a direction parallel to the longitudinal axis of the apparatus.

The perforated member may be movable bidirectionally along a longitudinal axis. In other words, the perforated member may be movable relative to the nozzles in a first direction at a first time, and subsequently be movable relative to the nozzles in a second direction, opposite the first direction, at a second time. Thus, the item may be cleaned particularly effectively. It may be that the apparatus comprises a roller or rollers to support the perforated member and facilitate bidirectional movement of the perforated member relative to the nozzles.

In other examples, the perforated member may be movable only unidirectionally, such as where the perforated member forms a continuous belt member, to be moved to move the item to be cleaned through the nozzles in one direction.

Through the presence of a roller or rollers on which the perforated member May move, the item to be cleaned may be moved through the downwardly and upwardly projecting jets of fluid so that the whole longitudinal extent of the item may be cleaned by these jets. Movement of the perforated member may be motorised. The roller or rollers may be motorised. Movement of the perforated member may be automated. Movement of the perforated member may be automated by controlling the operation of the roller or rollers. It will be apparent to the person skilled in the art that arrangements other than rollers may be used to move or facilitate movement of the perforated member relative to the nozzles.

The apparatus may comprise one or more motors configured to cause movement of the perforated member relative to the nozzles during a cleaning operation of the apparatus.

It may be preferable to have upper nozzle means which address the leading and trailing edges of an instrument as it moves bidirectionally along a horizontal axis. This aids in ensuring that the instruments are clamped throughout the whole cleaning process as they encounter a downwards force for the entire time that they receive an upward force from the lower jet. Another example would be to have water sprayed from the top surface jet nozzles covering a wider area than the water sprayed from the bottom surface jet nozzles. This would also allow the instruments to be “clamped” in place.

An arrangement where the perforated member is movable, preferably bidirectionally, along a longitudinal axis of the apparatus, allows a plurality of items to be cleaned to be placed on the perforated member spread out along the direction corresponding to the longitudinal axis of the apparatus. In this way, multiple items may be cleaned during a single operation of the apparatus. Viewed another way, this allows the same nozzles to be used to supply jets of fluid to multiple regions on the perforated member, for example allowing larger items to be cleaned, and/or multiple items to be cleaned.

The perforated member may be arranged to support a plurality of items to be cleaned. The perforated member may be arranged to support at least five items. The perforated member may be arranged to support at least ten items. The perforated member may have a length of at least 40 centimetres in the longitudinal direction. The perforated member may have a length of at least 60 centimetres in the longitudinal direction. The perforated member may have a width less than the length.

The present disclosure also extends to a method of cleaning an item using an apparatus herein disclosed. The method of cleaning, which may be pre-cleaning, an item, typically a surgical instrument, comprises the following steps: providing the item to be cleaned on the perforated member; and causing at least one downwardly projecting first jet of fluid produced by at least one upper nozzle and at least one upwardly projecting second jet of fluid produced by at least one lower nozzle to impinge on the item thereby causing debris from the item to be dislodged. The vertical component of a first jet force acting on the item from the at least one first jet is greater than the vertical component of a second jet force acting on the item from the at least one second jet.

The item may remain loose on the perforated member during cleaning. In other words, it may be that no physical restraint is used to retain the item on the perforated member.

This provides a method of cleaning, in particular of pre-cleaning, of surgical instruments which is particularly efficient and effective.

With a suitable arrangement of the jets, the item being cleaned is clamped by the net jet force onto the perforated member. No additional securing means is required.

The present method may further comprise moving the perforated member (e.g. bidirectionally) in a direction parallel to the longitudinal axis of the apparatus, thereby causing the item to move relative to the at least one first jet and the at least one second jet. Thus, the at least one first jet and the at least one second jet move over the item and impact multiple regions of the item.

Furthermore, moving the perforated member in this way enables items to be placed on the perforated member along the length of the perforated member and facilitates the cleaning or pre-cleaning of a plurality of items in a single cleaning cycle.

The item may be a hinged instrument. The item may be a device. The item may be a medical device. The item may be a reusable medical device. The item may be a surgical device. The item may be a hinged surgical instrument. The hinged surgical instrument may be surgical forceps. The hinged surgical instrument may be surgical scissors. The item may comprise a box joint.

It will be understood that the term surgical instrument includes surgical devices.

The method may comprise providing the hinged surgical instrument on the perforated member, with the hinge opened to expose a hinge joint of the hinged surgical instrument for cleaning.

### DESCRIPTION OF THE DRAWINGS

Example embodiments of the present invention will now be illustrated with reference to the following figures in which:

FIGS. 1a and 1b show schematic illustrations of cross sectional views of two apparatus as described herein;

FIG. 2 shows a schematic illustration of a further example of an apparatus in operation, the apparatus comprising three banks of nozzles (a) in planar view, and (b) 8 in cross-sectional view;

FIG. 3 shows forceps placed in a basket of an apparatus;

FIG. 4 shows a flow diagram in accordance with a method of using an apparatus as described herein; and

FIG. 5 shows a schematic illustration of a cross-sectional view of another example of an apparatus as described herein.

### DETAILED DESCRIPTION OF AN EXAMPLE EMBODIMENT

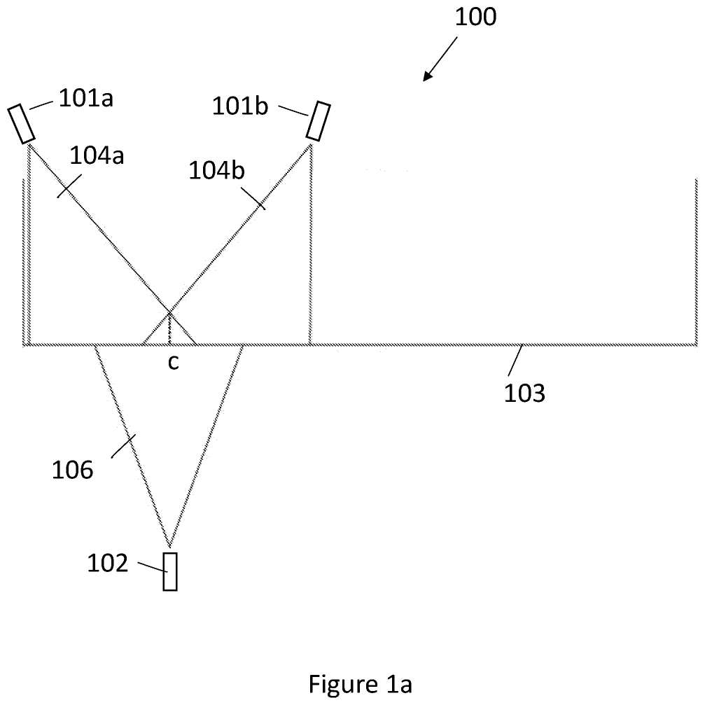

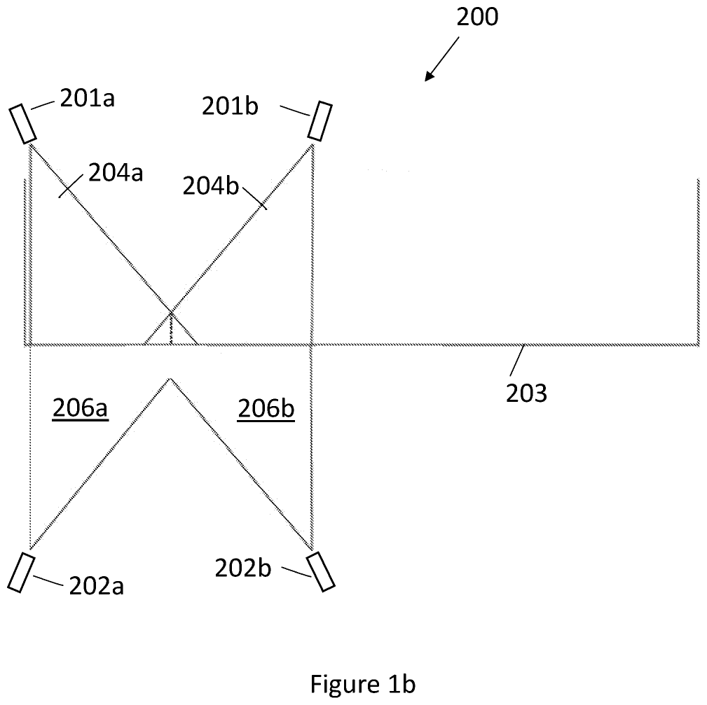

FIG. 1a shows a schematic diagram of the apparatus 100 of the present disclosure. The item or items to be cleaned (typically a forceps, not illustrated) are supported on a perforated member in the form of a basket 103. Two upper nozzles 101a, 101b are provided above the basket 103, each directed in a downward direction, and each producing a diverging first jet of fluid 104a, 104b to impinge upon the forceps when supported by the basket 103. A lower nozzle 102 is provided beneath the basket 103, directed in an upward direction, producing a diverging second jet of fluid 106 impacting the forceps from below the item supported by the basket 103.

The apparatus is configured such that the vertical component of a first jet force acting on the forceps to be cleaned from the first jets 104a, 104b is greater than the vertical component of a second jet force acting on the item to be cleaned from the second jet 106. The resulting imbalance of force from the jets results in a net downwards force on the forceps, which serves to clamp the forceps to the basket floor.

The central axis of a left upper nozzle 101a is directed towards the central axis of the other upper nozzle 101b in a symmetric way. In the illustrated embodiment, each upper nozzle 101a, 101b has been rotated relative to the vertical by an angle which results in the other edge of the diverging jet produced 104a, 104b being vertical. In this way the forceps is subjected to a horizontal force from each of two sides. The balance of forces is such that the forceps is always pushed back to a central position (c) between the two upper nozzles. If the forceps moves to the right, the horizontal force from the right increases, and the horizontal force from the left decreases. Therefore, if the forceps moves to the right from central position (c), it will be pushed naturally back to the central position. Similarly, if the forceps moves to the left from the central position (c), it will be pushed naturally back towards the centre again.

In this embodiment, the basket 103 has walls giving it a depth of 50 mm. The stand off or vertical distance of the upper nozzles 101a, 101b from the basket floor is 60 mm. The stand off or vertical distance of the lower nozzle 102 from the basket floor is 80 mm.

Each of the nozzles 101a, 101b, 102 is a commercially available 40° flat fan nozzle. In this embodiment the upper nozzles are spaced 84 mm apart. The overlap of the two downwardly projecting jets 101a, 101b is around 10 mm in a horizontal direction.

FIG. 1a shows an arrangement of nozzles 101a, 101b, 102, sometimes referred to as a group of nozzles in a nozzle bank, at one side of the basket 103, viewed from an end-on direction (with the longitudinal direction into the page). A similar unillustrated arrangement of nozzles may be present at the other side of the basket. The item to be cleaned, typically a forceps, extends in the plane of the drawing sheet so that it is covered by fluid present in diverging first jets 104a, 104b and diverging second jet 106. When the apparatus is in operation and providing a cleaning function, basket 103 moves in a direction perpendicular to the plane of the drawing sheet (i.e., into or out of the page), sometimes referred to as a longitudinal direction, and may do so bidirectionally, that is to say the basket may move in one direction and then stop and return along the same path but in the opposite direction. In this way, the whole of the length of an item being cleaned and placed under the upper nozzles 101a, 101b is impacted by diverging first jets 104a, 104b and diverging second jets 106. The cleaning effect of the diverging jets is thus imparted to the whole of the item. It will be understood that any further items positioned at another lateral position in the basket can be cleaned using nozzles in further nozzle banks, laterally offset from the illustrated nozzle bank. 36 FIG. 1b shows a further example of an apparatus 200, similar to the apparatus 100 shown in FIG. 1a, apart from the hereinafter noted distinctions. In addition to the first upper nozzle 201a producing the first downwardly projecting jet 204a and the second upper nozzle 201b producing the second downwardly projecting jet 204b, there is also provided a first lower nozzle 202a producing a first upwardly projecting jet 206a and a second lower nozzle 202b producing a second upwardly projecting jet 206b. The first lower nozzle 202a is arranged substantially directly vertically below the first upper nozzle 201a and the second lower nozzle 202b is arranged substantially directly vertically below the second upper nozzle 201b. In this way, it can be seen that substantially every region in the first and second downwardly projecting jets 204a, 204b will intersect with one or more of the first and second upwardly projecting jets 206a, 206b, below the height of the basket 203 (as a result of the increased distance between the lower nozzles 202a, 202b and the basket 203, compared to the distance between the upper nozzles 201a, 201b and the basket 203).

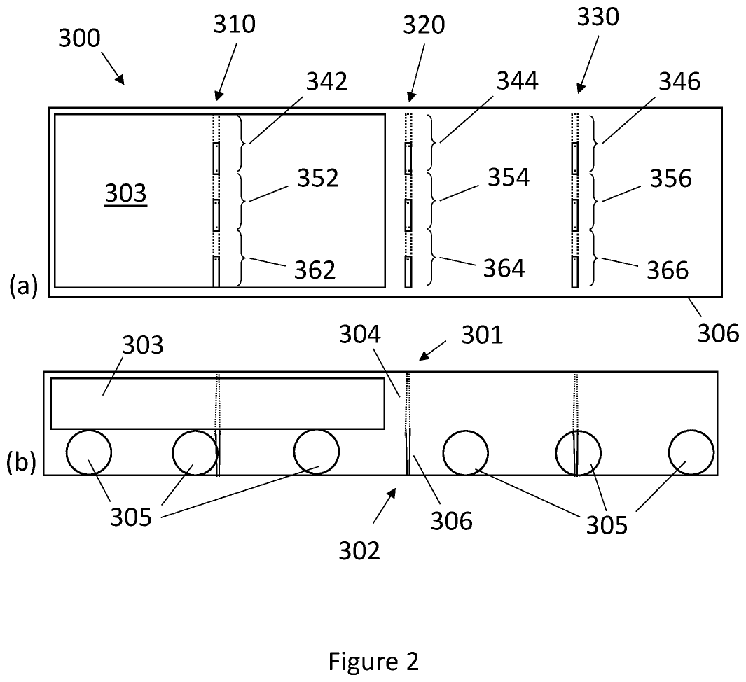

FIG. 2 shows (a) a plan view, and (b) a side view of a different embodiment 300 of the apparatus. The nozzles are not shown in this schematic drawing, though an upper nozzle 301 and a lower nozzle 302 are indicated for information in FIG. 2(b), but the jets produced by the nozzles when the apparatus is in operation are illustrated. The diverging jets in the embodiment of FIG. 2 are fan-shaped.

As well as the basket 303 the downwardly projecting diverging jets 304, and the upwardly projecting diverging jets 306, FIG. 2 also shows a cleaning vessel 306 within which the basket 303 and the nozzles 301, 302 are contained; and rollers 305 for facilitating bidirectional movement of the basket 303. The nozzles in this embodiment are arranged in three nozzle banks 310, 320, 330, each having three nozzle groups 342, 344, 346, 352, 354, 356, 362, 364, 366 therein, although clearly the number of nozzle banks and nozzle groups is illustrative and no particular significance is associated with three banks or three nozzle groups. There are four nozzles in each nozzle group associated with each nozzle bank, being two upper nozzles 301 and two lower nozzles 302, substantially as described with reference to FIG. 1b hereinbefore. The first nozzle bank 310 comprises four nozzles in the first nozzle group 342, four nozzles in the second nozzle group 352 and four nozzles in the third nozzle group 362. Each of the nozzles in the first nozzle bank 310 are located substantially at a first longitudinal position within the apparatus 300. The second nozzle bank 320 comprises four nozzles in the first nozzle group 344, four nozzles in the second nozzle group 354 and four nozzles in the third nozzle group 364. Each of the nozzles in the second nozzle bank 320 are located substantially at a second longitudinal position within the apparatus 300, spaced from the first longitudinal position. The third nozzle bank 330 comprises four nozzles in the first nozzle group 346, four nozzles in the second nozzle group 356 and four nozzles in the third nozzle group 366. Each of the nozzles in the third nozzle bank 330 are located substantially at a third longitudinal position within the apparatus 300, spaced from the first and second longitudinal positions. Each nozzle group associated with a given nozzle bank is laterally spaced from each other nozzle group associated with the same respective nozzle bank.

FIG. 2 illustrates fan-shaped diverging jets, each of which has a vertical centrally directed axis. It is apparent however that the diverging jets need not be axially vertically directed. In order to cover the whole of a forceps or other instrument being cleaned, a set of flat fan nozzles for producing fan-shaped diverging jets would naturally be configured such that a plane of the fan was parallel to a lateral direction (a width) of the apparatus 300. An arrangement in which a set of nozzles is spread out along the width direction of the apparatus also has the advantage that an arrangement of inwardly directed nozzles may be utilised, that is an arrangement in which the central axes of upper nozzles in a nozzle set are directed towards each other. As discussed, such an arrangement produces a net horizontal force on the forceps which pushes the forceps towards a position central to the two nozzles. This can be important in stabilising the forceps during cleaning.

The basket 303 in FIG. 2(a) and FIG. 2(b) is shown at the left end of the cleaning vessel 306. Surgical instruments for cleaning, such as forceps, are placed on the basket and it is apparent that as the basket moves from left to right in the figure, from one extreme position as illustrated to the other extreme position at the right side of the figure, the instruments pass through the fan-shaped jets 304, 306, being impacted by the jets 304, 306 as they do so. Debris is removed from the instruments as they are sprayed by the jets. The basket may move bidirectionally along the length direction of the apparatus. In this way the forceps may pass through a set of nozzles more than once. This may be advantageous in the removal of dogged debris.

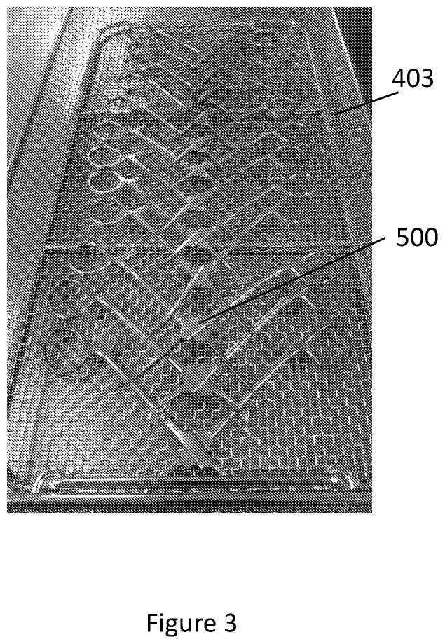

FIG. 3 is a photograph of the basket 403 of an apparatus as herein disclosed. Placed in the basket is a multitude of forceps 500. The forceps 500 are lying loosely and are placed on the basket 403 in an open configuration. There is no mechanical restraint of the forceps in the basket, such as a clip or a clamp. As disclosed the jets of the present disclosure have the effect of clamping the forceps to the basket floor and also of keeping them centred within the basket. The joint of the forceps is slightly opened and closed through forces applied by the jets. The forces experienced by any particular area of the forceps change as the forceps move through the jets. The nozzles may also be controlled to reduce water wastage and energy consumption by the cleaning apparatus.

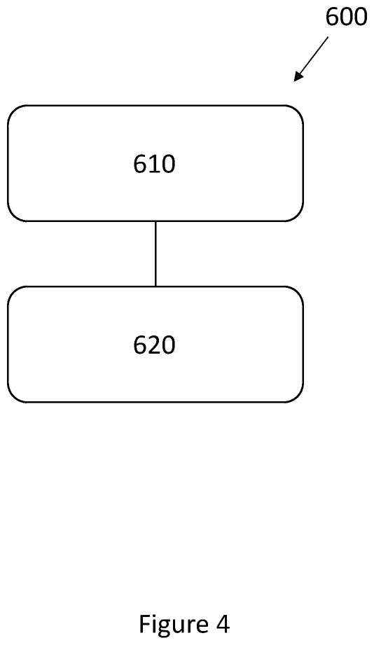

FIG. 4 illustrates in a flow diagram a method 600 of cleaning an item using an apparatus according to the present disclosure. In a first method step 610, the item or items to be cleaned, such as a forceps, is provided on the perforated member, in the form of the basket. Typically, the item or items to be cleaned are supported loosely at the basket. In a second method step 620, at least one downwardly projecting first jet of fluid produced by at least one upper nozzle is caused to impinge on the item thereby causing debris from the item to be dislodged.

The method 600 of cleaning an item using the apparatus typically further comprises causing at least one upwardly projecting second jet of fluid produced by at least one lower nozzle to impinge on the item, whereby the vertical component of a first jet force acting on the item from the at least one first jet is greater than the vertical component of a second jet force acting on the item from the at least one second jet. In this way debris is further dislodged from the item using a powerful jet wash without requiring any physical clamping of the item to be cleaned. Typically, the upwardly projecting second jet is produced simultaneously to the first jet, in other words at the same time as the second step 620.

Furthermore, the method may additionally comprise moving the basket bidirectionally in a direction parallel to the longitudinal axis of the apparatus, thereby causing the item to move relative to the at least one first jet and the at least one second jet, with the effect that the at least one first jet and the at least one second jet move over the item and impact the whole surface area of the item. Movement of the basket May preferably occur while first and/or second jets of fluid are being produced by the nozzles.

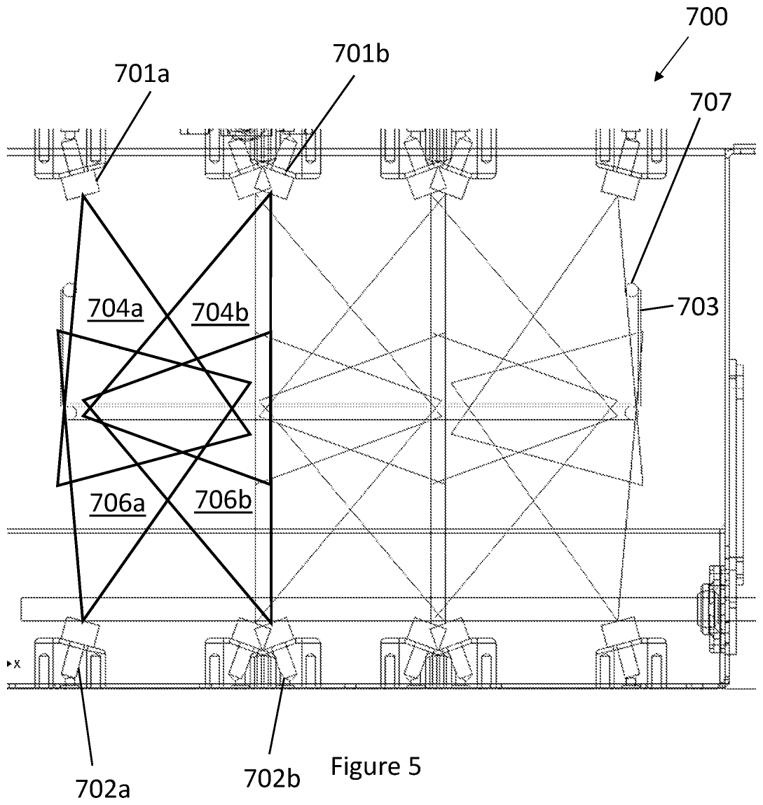

FIG. 5 shows a schematic illustration of a cross-sectional view of another example of an apparatus as described herein. The apparatus 700 is an alternative to the apparatus described hereinbefore. The apparatus 700 includes an equal number of upper nozzles 701a, 701b and lower nozzles 702a, 702b. The basket 703 includes a side wall having an internal bar 707 at an upper end thereof. The internal bar 707 extends within a footprint of the basket. As a result, the outermost upper nozzle 701a is angled such that the downwardly projecting diverging jet 704a projected therefrom still penetrates to the corner of the basket 703, past the internal bar 707. In other words, the outermost extent of the downwardly projecting diverging jet 704a extends slightly outwardly relative to the vertical. In contrast, the upper nozzles 701b other than the outermost upper nozzles 701a are arranged such that their respective downwardly projecting diverging jets 704b, projecting therefrom, have an extent on one side which is substantially vertical. It will be understood that the outermost lower nozzle 702a having the upwardly projecting diverging jets 706a projecting therefrom are arranged to be symmetrical with the outermost upper nozzle 701a about a horizontal plane (typically parallel to a base of the basket 703). Similarly, the lower nozzles 702b other than the outermost lower nozzles 702a are arranged such that their respective upwardly projecting diverging jets 706b, projecting therefrom, have an extent on one side which is substantially vertical, thereby being symmetrical with the other upper nozzles 702a about the horizontal plane. In this way, instruments even in the corners of the basket 703 can be cleaned by the high pressure jets, and can even be slightly pushed into and pinned against the corners because the jets at the corners result in a non-zero lateral force component, pushing outwardly towards the corner of the basket 703.

In summary, there is provided apparatus (100, 200, 300) for cleaning an item. The apparatus comprises: a perforated member (103, 203, 303) for supporting an item to be cleaned; at least one upper nozzle (101a, 101b, 201a. 201b, 301) provided above the perforated member, directed in a downward direction, and for producing at least one first jet of fluid (104a, 104b, 204a, 204b, 304) to impinge upon the item when supported by the perforated member; and at least one lower nozzle (102, 202a, 202b, 302) provided beneath the perforated member, directed in an upward direction, and for producing at least one second jet of fluid (106, 206a, 206b, 306) to impinge upon the item when supported by the perforated member. The apparatus is configured such that when the at least one first jet and the at least one second jet are produced, the vertical component of a first jet force acting on the item to be cleaned from the at least one first jet is greater than the vertical component of a second jet force acting on the item to be cleaned from the at least one second jet.

Throughout the description and claims of this specification, the words “comprise” and “contain” and variations of them mean “including but not limited to”, and they are not intended to and do not exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An apparatus for cleaning an item, the apparatus comprising:
a perforated member defining a surface for supporting an item to be cleaned;
a plurality of upper nozzles provided above the perforated member, directed in a downward direction, and for producing at least one first jet of fluid to impinge upon the item when supported by the perforated member; and
a plurality of lower nozzles provided beneath the perforated member, directed in an upward direction, and for producing at least one second jet of fluid to impinge upon the item when supported by the perforated member, wherein the apparatus is configured such that when the at least one first jet and the at least one second jet are produced, the vertical component of a first jet force acting on the item to be cleaned from the at least one first jet is greater than the vertical component of a second jet force acting on the item to be cleaned from the at least one second jet,
wherein each nozzle is configured to produce a diverging jet of fluid,
wherein the total number of upper nozzles is equal to the total number of lower nozzles,
wherein a first of the plurality of upper nozzles is arranged to direct a first associated jet in a first combined resultant direction at least partially towards a second combined resultant direction of a second associated jet for which a second of the plurality of upper nozzles is arranged, and
wherein each of the outermost upper nozzles is configured such that a horizontal component of a direction of an outer jet wall of each of the outermost upper nozzles is less than a horizontal component of a direction of an inner jet wall of each of the outermost upper nozzles,
wherein the pressure of fluid supplied to the nozzles is from 5×10⁶ Pa to 500×10⁶ Pa.

2. The apparatus according to claim 1, wherein the diverging jet of fluid is fan-shaped.

3. The apparatus according to claim 2, wherein a respective plane of each fan-shaped jet of fluid is perpendicular to a longitudinal axis of the apparatus.

4. (canceled)

5. The apparatus according to claim 1, wherein each upper nozzle is arranged relative to a respective lower nozzle such that each first jet intersects the respective second jet from the respective lower nozzle.

6. The apparatus according to claim 1, wherein the shortest distance between the perforated member and the plurality of upper nozzles is less than the shortest distance between the perforated member and the plurality of lower nozzles.

7. The apparatus according to claim 1, wherein the plurality of upper nozzles and the plurality of lower nozzles are provided in a first nozzle bank and the apparatus comprises a plurality of nozzle banks.

8. The apparatus according to claim 1, wherein the apparatus is configured such that the perforated member is movable relative to the nozzles, in a direction parallel to the or a longitudinal axis of the apparatus.

9. The apparatus according to claim 8, whereby the perforated member is movable bidirectionally along the longitudinal axis.

10. The apparatus according to claim 8, further comprising a roller or rollers to support the perforated member and facilitate movement of the perforated member.

11. The apparatus according to claim 1, further comprising a nozzle controller to control selective activation of the plurality of upper nozzles and the plurality of lower nozzles.

12. The apparatus according to claim 1, further comprising:
a variable pump in fluid communication with one or more of the plurality of upper nozzles and the plurality of lower nozzles; and
a pump controller to control an output of the variable pump.

13. A method of cleaning an item using an apparatus according claim 1, whereby the method comprises the following steps:
providing the item to be cleaned on the perforated member, to be supported loosely by the surface of the perforated member; and
causing a plurality of downwardly projecting first jets of fluid produced by a plurality of upper nozzles and a plurality of upwardly projecting second jets of fluid produced by a plurality of lower nozzles to impinge on the loose item thereby causing debris from the item to be dislodged,
wherein the vertical component of a first resultant jet force acting on the item from the plurality of first jets is greater than the vertical component of a resultant second jet force acting on the item from the plurality of second jets.

14. The method according to claim 13 additionally comprising moving the perforated member bidirectionally in a direction parallel to a longitudinal axis of the apparatus, thereby causing the item to move relative to the plurality of first jets and the plurality of second jets.

15. The method according to claim 13, wherein the item is a hinged surgical instrument, and wherein the method comprises providing the hinged surgical instrument on the perforated member, with the hinge opened to expose a hinge joint of the hinged surgical instrument.

16. The method according to claim 15, wherein the hinged surgical instrument is surgical scissors or surgical forceps.

17. The apparatus according to claim 1, wherein the fluid is cleaning fluid.

18. (canceled)

19. The apparatus according to claim 1, wherein each of the outermost upper nozzles is configured such that the horizontal component of the direction of the outer jet wall of each of the outermost upper nozzles in the outer direction is between zero and less than the horizontal component of the direction of the inner jet wall of each of the outermost upper nozzles in the inner direction.

20. The method according to claim 13, wherein the fluid is cleaning fluid.

21. The method according to claim 13, wherein each of the outermost upper nozzles is configured such that the horizontal component of the direction of the outer jet wall of each of the outermost upper nozzles in the outer direction is between zero and less than the horizontal component of the direction of the inner jet wall of each of the outermost upper nozzles in the inner direction.
